(19) United States
(12) Patent Application Publication
(10) Pub. No.: US 2018/0035278 A1
(43) Pub. Date: Feb. 1, 2018

(54) APPARATUS AND METHOD FOR PROXIMITY-BASED SERVICE COMMUNICATION

(71) Applicant: NEC CORPORATION, Tokyo (JP)

(72) Inventors: Hiroaki AMINAKA, Tokyo (JP); Hisashi FUTAKI, Tokyo (JP)

(21) Appl. No.: 15/551,474

(22) PCT Filed: Nov. 17, 2015
(86) PCT No.: PCT/JP2015/005710

§ 371 Date: Aug. 16, 2017

(30) Foreign Application Priority Data
Feb. 26, 2015 (JP) 2015-036287

(51) Int. Cl. H04W 8/00; H04W 72/04; H04W 4/00; H04W 48/08; H04W 64/00

(52) U.S. Cl. CPC H04W 8/005; H04W 48/08; H04W 64/006; H04W 4/008; H04W 72/048

(57) ABSTRACT

A radio access network node (21) detects an event that triggers an occurrence of sidelink communication (103) including at least one of direct discovery and direct communication. In response to detection of the event, the radio access network node (21) acquires location information of at least one of a plurality of radio terminals (1) that participate in the sidelink communication. It is thus, for example, possible to contribute to improving sidelink communication including direct discovery and direct communication.

### TECHNICAL FIELD

The present application relates to Proximity-based services (ProSe) and, in particular, to direct discovery and direct communication that are performed by using a direct interface between radio terminals.

### BACKGROUND ART

The 3GPP Release 12 specifies Proximity-based services (ProSe) (see, for example. Non-patent Literature 1). ProSe includes ProSe discovery and ProSe direct communication. ProSe discovery makes it possible to detect proximity of radio terminals. ProSe discovery includes direct discovery (ProSe Direct Discovery) and network-level discovery (EPC-level ProSe Discovery).

ProSe Direct Discovery is performed through a procedure in which a radio terminal capable of performing ProSe (i.e., ProSe-enabled UE) detects another ProSe-enabled UE by using only the capability of a radio communication technology (e.g., Evolved Universal Terrestrial Radio Access (E-UTRA) technology) possessed by these UEs. On the other hand, in EPC-level ProSe Discovery, a core network (i.e., Evolved Packet Core (EPC)) determines proximity of two ProSe-enabled UEs and notifies these UEs of detection of proximity. ProSe Direct Discovery may be performed by three or more ProSe-enabled UEs.

ProSe direct communication enables establishment of a communication path between two or more ProSe-enabled UEs existing in a direct communication range after the ProSe discovery procedure is performed. In other words, ProSe direct communication enables a ProSe-enabled UE to directly communicate with another ProSe-enabled UE, without communicating through a Public Land Mobile Network (PLMN) including a base station (eNodeB). ProSe direct communication may be performed by using a radio communication technology that is also used to access a base station (eNodeB) (i.e., E-UTRA technology) or by using a wireless radio access network (WLAN) radio technology (i.e., IEEE 802.11 radio technology).

According to 3GPP Release 12, a ProSe function communicates with a ProSe-enabled UE through a Public Land Mobile Network (PLMN) and assists ProSe discovery and ProSe direct communication. The ProSe function is a logical function that is used for PLMN-related operations required for ProSe. The functionality provided by the ProSe function includes, for example: (a) communication with third-party applications (a ProSe Application Server); (b) authentication of a UE for ProSe discovery and ProSe direct communication; (c) transmission of configuration information for ProSe discovery and ProSe direct communication (e.g., EPC-ProSe-User ID) to a UE; and (d) provision of network-level discovery (i.e., EPC-level ProSe discovery). The ProSe function may be implemented in one or more network nodes or entities. In this specification, one or more network nodes or entities that implement the ProSe function are referred to as a “ProSe function entity” or a “ProSe function server”.

As described above, ProSe direct discovery and ProSe direct communication are performed on an inter-UE direct interface. This direct interface is referred to as a PC5 interface or a sidelink. Hereinafter, in this specification, communication including at least one of direct discovery and direct communication is referred to as “sidelink communication”.

A UE needs to communicate with a ProSe function before performing sidelink communication (see Non-patent Literature 1). In order to perform ProSe direct communication and ProSe direct discovery, the UE has to communicate with the ProSe function and acquire authentication information by the PLMN from the ProSe function in advance. Further, in the case of ProSe direct discovery, the UE has to transmit a discovery request to the ProSe function. Specifically, when the UE desires transmission (announcement) of discovery information on the sidelink, the UE transmits to the ProSe function a discovery request for the announcement. On the other hand, when the UE desires reception (monitoring) of discovery information on the sidelink, the UE transmits to the ProSe function a discovery request for the monitoring. Then, when the discovery request has succeeded, the UE is permitted to transmit or receive the discovery information on the inter-UE direct interface (e.g., sidelink or PC5 interface).

The allocation of radio resources for the sidelink communication to n UE is performed by a radio access network (e.g., Evolved Universal Terrestrial Radio Access Network (E-UTRAN)) (see Non-patent Literatures 1 and 2). The UE which is permitted to perform the sidelink communication by the ProSe function performs ProSe direct discovery or ProSe direct communication by using radio resources configured by a radio access network node (e.g., eNodeB). Sections 23.10 and 23.11 of Non-patent Literature 2 describe details of the allocation of radio resources for the sidelink communication to a UE.

Regarding ProSe direct communication, two resource allocation modes, i.e., Scheduled resource allocation and Autonomous resource selection are specified. In the Scheduled resource allocation for ProSe direct communication, a UE requests an eNodeB to allocate resources and the eNB schedules resources for sidelink control and data for the UE. Specifically, the UE sends to the eNodeB a scheduling request together with a ProSe Buffer Status Report (BSR).

In the Autonomous resource selection of ProSe direct communication, a UE autonomously selects resources for sidelink control and data from a resource pool(s). An eNodeB may allocate a resource pool(s) for the Autonomous resource selection to a UE in a System Information Block (SIB) 18. The eNodeB may allocate a resource pool for the Autonomous resource selection to a UE in Radio Resource Control (RRC)_CONNECTED via dedicated RRC signaling. This resource pool may be available when the UE is in RRC_IDLE.

Regarding ProSe direct discovery, two resource allocation modes, i.e., Scheduled resource allocation and Autonomous resource selection are also specified. In the Autonomous resource selection for ProSe direct discovery, a UE that desires transmission (announcement) of discovery information autonomously selects radio resources from a resource pool(s) for announcement. This resource pool is configured in UEs via broadcast (SIB 19) or dedicated signaling (RRC signaling).

In the Scheduled resource allocation for ProSe direct discovery, a UE requests an eNodeB to allocate resources for announcement via RRC signaling. The eNB allocates resources for announcement from a resource pool that is configured in UEs for monitoring. When the Scheduled resource allocation is used, the eNB indicates in SIB 19 that it provides resources for monitoring of ProSe direct discovery but does not provide resources for announcement.

Note that 3GPP Release 12 ProSe is one example of proximity-based services (ProSe) that are provided based on geographic proximity of a plurality of radio terminals. Similarly to 3GPP Release 12 ProSe, the proximity-based service in a public land mobile network (PLMN) includes discovery and direct-communication phases assisted by a function or a node (e.g., ProSe function) located in the network. In the discovery phase, geographic proximity of radio terminals is determined or detected. In the direct communication phase, the radio terminals perform direct communication. The direct communication is performed between radio terminals in proximity to each other, without communicating through a public land mobile network (PLMN). The direct communication is also referred to as “device-to-device (D2D) communication” or “peer-to-peer communication”. In this specification, the term “ProSe” is not limited to 3GPP Release 12 ProSe and refers to proximity-based service communication including at least one of discovery and direct communication. Further, each of the terms “proximity-based service communication” and “ProSe communication” in this specification refers to at least one of the discovery and the direct communication.

The term “public land mobile network (PLMN)” in this specification indicates a wide-area radio infrastructure network, and means a multiple-access mobile communication system. The multiple-access mobile communication system enables mobile terminals to perform radio communication substantially simultaneously by sharing radio resources including at least one of time resources, frequency resources, and transmission power resources among the mobile terminals. Typical examples of multiple-access technology Include Time Division Multiple Access (TDMA). Frequency Division Multiple Access (FDMA), Code Division Multiple Access (CDMA), Orthogonal Frequency Division Multiple Access (OFDMA), and any combination thereof. The public land mobile network includes a radio access network and a core network. Examples of the public land mobile network include a 3GPP Universal Mobile Telecommunications System (UMTS), a 3GPP Evolved Packet System (EPS), a 3GPP2 CDMA2000 system, a Global System for Mobile communications (GSM (Registered Trademark))/General packet radio service (GPRS) system, a WiMAX system, and a mobile WiMAX system. The EPS includes a Long Term Evolution (LTE) system and an LTE-Advanced system.

### CITATION LIST

### Patent Literature

Patent Literature 1: Japanese Unexamined Patent Application Publication No. 2005-033536

### Non Patent Literature

Non-patent Literature 1: 3GPP TS 23.303 V12.3.0 (2014-12), “3rd Generation Partnership Project; Technical Specification Group Services and System Aspects; Proximity-based services (ProSe); Stage 2 (Release 12)”, December 2014
Non-patent Literature 2: 3GPP TS 36.300 V12.4.0 (2014-12), “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 12)”, December 2014

### SUMMARY OF INVENTION

### Technical Problem

Non-patent Literatures 1 and 2 describes that a base station (eNodeB) allocates radio resources for the sidelink communication including direct discovery and direct communication. However, Non-patent Literatures 1 and 2 do not describe that the location of a radio terminal (UE) is taken into account in a base station (eNodeB) when permitting the sidelink communication or allocating radio resources for the sidelink communication.

Patent Literature 1 describes that when a switch node receives calling information from a sender radio terminal through a base station, it inquires a subscriber database about the locations of the sender and receiver radio terminals. The switch node disclosed in Patent Literature 1 instructs the sender radio terminal to activate direct communication when the sender and receiver radio terminals are located in the same base station area (cell) or adjacent base station areas. However, Patent Literature 1 also does not disclose that a radio access network node (e.g., base station) located in a radio access network takes into account the location of a radio terminal when it permits sidelink communication or allocates radio resources for the sidelink communication.

If the location of a radio terminal is not taken into account in a base station when it permits the sidelink communication or allocates radio resources for the sidelink communication, the following problem or inconvenience may occur. For example, in the case where two radio terminals are distant from each other though they are located in the same cell (i.e., intra-cell) or adjacent cells (i.e., inter-cell), these two radio terminals cannot perform communication even if a radio access network node allocates radio resources for the sidelink communication. As a result, this would cause waste of radio resource and waste of battery power of the radio terminals. Further, for example, when the location of a radio terminal is not taken into account by a radio access network node, it may be impossible to make an appropriate radio setting (e.g., transmission power, a modulation scheme, or a coding rate) according to the inter-terminal distance between radio terminals that perform the sidelink communication.

One of the objects to be attained by embodiments disclosed herein is to provide an apparatus, a method, and a program that contribute to improving sidelink communication including direct discovery and direct communication.

### Solution to Problem

In a first aspect, a radio access network node, located in a radio access network, includes a memory and at least one processor coupled to the memory. The at least one processor is configured to detect an event that triggers an occurrence of sidelink communication including at least one of direct discovery and direct communication. Further, the at least one processor is configured to acquire, in response to detection of the event, location information of at least one of a plurality of radio terminals that participate in the sidelink communication.

In a second aspect, a radio terminal includes a memory and at least one processor coupled to the memory. The at least one processor is configured to transmit to a radio access network node an indication regarding sidelink communication including at least one of direct discovery and direct communication. Further, the at least one processor is configured to transmit location information of the radio terminal to the radio access network node in response to a request from the radio access network node that has received the indication. Furthermore, the at least one processor is configured to receive from the radio access network node a message indicating whether the sidelink communication is permitted or not, or indicating a radio setting for the sidelink communication.

In a third aspect, a method performed by a radio access network node includes: (a) detecting an event that triggers an occurrence of sidelink communication including at least one of direct discovery and direct communication; and (b) acquiring, in response to detection of the event, location information of at least one of a plurality of radio terminals that participate in the sidelink communication.

In a fourth aspect, a method performed by a radio terminal includes: (a) transmitting to a radio access network node an indication regarding sidelink communication including at least one of direct discovery and direct communication to a radio access network node; (b) transmitting location information of the radio terminal to the radio access network node in response to a request from the radio access network node that has received the indication; and (c) receiving from the radio access network node a message indicating whether the sidelink communication is permitted or not, or indicating a radio setting for the sidelink communication.

In a fifth aspect, a radio access network node includes a memory and at least one processor coupled to the memory. The at least one processor is configured to take into account location information of at least one of a plurality of radio terminals that participate in sidelink communication including at least one of direct discovery and direct communication, when activating the sidelink communication, when permitting the sidelink communication, when allocating a radio resource for the sidelink communication, or when determining a radio setting for the sidelink communication.

In a sixth aspect, a method performed by a radio access network node includes taking into account location information of at least one of a plurality of radio terminals that participate in sidelink communication including at least one of direct discovery and direct communication, when activating a sidelink communication, when permitting the sidelink communication, when allocating a radio resource for the sidelink communication, or when determining a radio setting for the sidelink communication.

In a seventh aspect, a program includes a set of Instructions (software codes) that, when loaded into a computer, causes the computer to perform a method according to the above-described third, fourth or sixth aspect,

### Advantageous Effects of Invention

According to the above-described aspects, it is possible to provide an apparatus, a method, and a program that contribute to improving sidelink communication including direct discovery and direct communication.

### BRIEF DESCRIPTION OF DRAWINGS

FIG. 1 shows a configuration example of a public land mobile network according to several embodiments;

FIG. 2 shows a configuration example of a public land mobile network according to several embodiments;

FIG. 3 is a flowchart showing an example of an operation of a radio access network node (e.g., eNodeB) according to a first embodiment;

FIG. 4 is a sequence diagram showing an example of a control procedure regarding sidelink communication according to the first embodiment;

FIG. 5 is a sequence diagram showing an example of a control procedure regarding sidelink communication according to the first embodiment;

FIG. 6 is a sequence diagram showing an example of a control procedure regarding sidelink communication according to the first embodiment;

FIG. 7 is a sequence diagram showing an example of a control procedure regarding sidelink communication according to the first embodiment;

FIG. 8 is a flowchart showing an example of an operation of a radio access network node (e.g., eNodeB) according to a second embodiment;

FIG. 9 is a sequence diagram showing an example of a control procedure regarding sidelink communication according to the second embodiment;

FIG. 10 is a flowchart showing an example of an operation of a radio terminal (e.g., UE) according to the second embodiment;

FIG. 11 is a flowchart showing an example of an operation of a radio access network node (e.g., eNodeB) according to a third embodiment;

FIG. 12 is a sequence diagram showing an example of a control procedure regarding sidelink communication according to the third embodiment;

FIG. 13 is a flowchart showing an example of an operation of a radio terminal (e.g., UE) according to the third embodiment;

FIG. 14 is a block diagram showing a configuration example of a radio access network node (e.g., eNodeB) according to several embodiments; and

FIG. 15 is a block diagram showing a configuration example of a radio terminal (e.g., UE) according to several embodiments.

### DESCRIPTION OF EMBODIMENTS

Specific embodiments are described hereinafter in detail with reference to the drawings. The same or corresponding elements are denoted by the same symbols throughout the drawings, and duplicated explanations are omitted as necessary for the sake of clarity.

Embodiments described below will be explained mainly using specific examples with regard to an Evolved Packet System (EPS). However, these embodiments are not limited to being applied to the EPS and may also be applied to other mobile communication networks or systems such as a 3GPP (UMTS), a 3GPP2 CDMA2000 system, a GSM/GPRS system, and a WiMAX system.

### First Embodiment

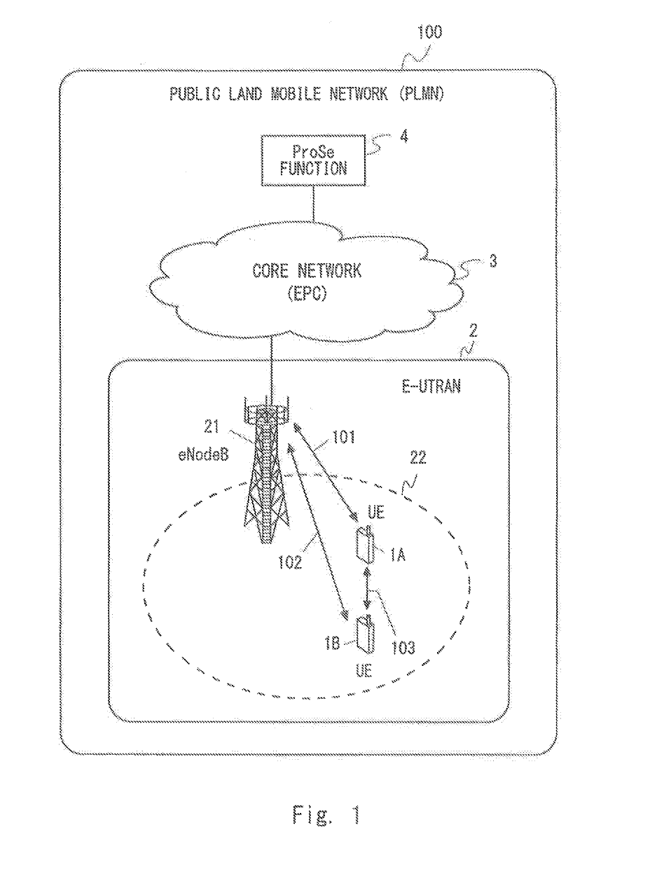

FIG. 1 shows a configuration example of a PLMN 100 according to this embodiment. Both a UE 1A and a UE 1B are radio terminals capable of performing ProSe (i.e., ProSe-enabled UEs), and they can perform sidelink communication on an inter-terminal direct Interface (i.e., PCS inter face or sidelink) 103. This sidelink communication includes at least one of ProSe direct discovery and ProSe direct communication. The sidelink communication is performed by using a radio communication technology that is also used to access a base station (eNodeB) 21 (e.g., E-UTR A technology).

The eNodeB 21 is an entity located in a radio access network (i.e., E-UTRAN) 2, manages a cell 22, and is able to perform communication (101 and 102) with the UEs 1A and 1B by using the E-UTRA technology. While FIG. 1 shows a situation where both the UE 1A and UE 1B are located in the identical cell 22 for the sake of clarity, such a UE arrangement is merely an example. For example, the UE 1A may be located within one of adjacent cells managed by different eNodeBs 21 and the UE 1B may be located within the other of the adjacent cells.

A core network (i.e., EPC) 3 includes a plurality of user-plane entities (e.g., Serving Gateway (S-GW) and a Packet Data Network Gateway (P-GW)) and a plurality of control-plane entities (e.g., Mobility Management Entity (MME) and a Home Subscriber Server (HSS)). The user-plane entities relay user data of the UEs 1A and 1B between the E-UTRAN 2 and an external network (Packet Data Network (PDN)). The control-plane entitles perform various types of control for the UEs 1A and 1B including mobility management, session management (bearer management), subscriber information management, and billing management.

In order to use a ProSe service (e.g., EPC-level ProSe Discovery, ProSe Direct Discovery, or ProSe Direct Communication), each of the UEs 1A and 1B attaches to the EPC 3 through the E-UTRAN 2, establishes a Packet Data Network (PDN) connection for communicating with a ProSe function entity 4, and transmits and receives ProSe control signaling to and from the ProSe function entity 4 through the E-UTRAN 2 and the EPC 3. The UEs 1A and 1B may use EPC-level ProSe Discovery provided by the ProSe function entity 4. The UEs 1A and 1B may receive, from the ProSe function entity 4, a message indicating permission for the UEs 1A and 1B to activate (enable) ProSe Direct Discovery or ProSe Direct Communication. The UEs 1A and 1B may receive, from the ProSe function entity 4, configuration information for ProSe Direct Discovery or ProSe Direct Communication in the cell 22.

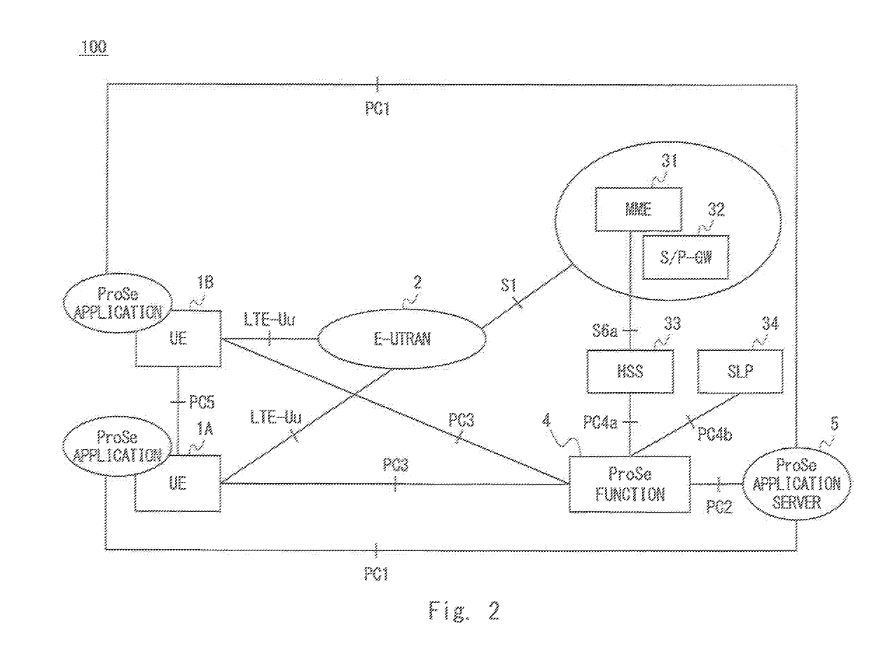

FIG. 2 shows reference points used for ProSe. Each reference point may also be referred to as an “interface”. FIG. 2 shows a non-roaming architecture in which the UEs 1A and 1B use a subscription of the same PLMN 100.

A PC1 reference point is a reference point between a ProSe application in each UE 1 (UEs 1A and 1B) and a ProSe application server 5. The PC1 reference point is used to define application-level signaling requirements.

A PC2 reference point is a reference point between the ProSe application server 5 and the ProSe function entity 4. The PC2 reference point is used to define interactions between the ProSe application server 5 and the ProSe functionality provided by the 3GPP EPS through the ProSe function entity 4.

A PC3 reference point is a reference point between each UE 1 (UEs 1A and 1B) and the ProSe function entity 4. The PC3 reference point is used to define interactions between the UE 1 and the ProSe function entity 4 (e.g., UE registration, application registration, and authorizations for ProSe Direct Discovery and EPC-level ProSe Discovery requests). The PC3 reference point depends on the user plane of the EPC 3 and, accordingly, ProSe control signaling between each UE 1 and the ProSe function entity 4 is transferred on this user plane.

A PC4a reference point is a reference point between the ProSe function entity 4 and an HSS 33. This reference point is used by the ProSe function entity 4, for example, to acquire subscriber information related to ProSe services.

A PC4b reference point is a reference point between the ProSe function entity 4 and a Secure User Plane Location (SUPL) Location Platform (SLP) 34. This reference point is used by the ProSe function entity 4, for example, to acquire location information of each UE 1 (UEs 1A and 1B). The SLP assists the UEs 1 in GPS positioning and receives measurement results from the UEs 1, thereby intermittently acquiring, from the UE 1, location reporting by which the current locations of the UEs 1 can be estimated.

A PC5 reference point is a reference point between UEs 1 (ProSe-enabled UEs), and is used for the control and user planes of ProSe Direct Discovery, ProSe Direct Communication, and ProSe UE-to-Network Relay.

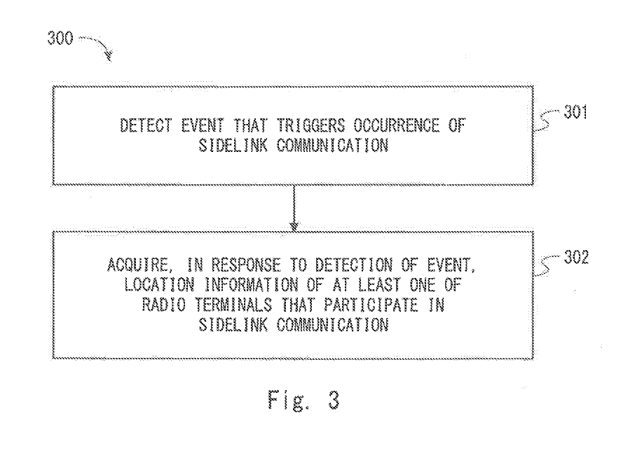

Next, a control procedure regarding the sidelink communication according to this embodiment is described. FIG. 3 is a flowchart showing an example (process 300) of an operation of an eNodeB 21 regarding the sidelink communication. In block 301, the eNodeB 21 detects an event that triggers an occurrence of sidelink communication.

For example, the event that triggers sidelink communication may be reception by the eNodeB 21 of an indication regarding the sidelink communication transmitted from one of the UEs 1 that participate in the sidelink communication. The indication regarding the sidelink communication may indicate that the UE 1 wants to perform the sidelink communication or that the UE 1 has an interest in the sidelink communication. Specifically, the indication regarding the sidelink communication may be a ProSe Direct indication indicating an interest in ProSe direct communication or may be a Discovery Indication indicating that the UE 1 wants to perform a ProSe direct discovery announcement. Alternatively, the indication regarding the sidelink communication may indicate a radio resource allocation request for the sidelink communication. Specifically, the indication regarding the sidelink communication may be a scheduling request (e.g., scheduling request with a ProSe BSR) for the sidelink communication transmitted from the UE 1 to the eNodeB 21.

Alternatively, the event that triggers sidelink communication may be reception by the eNodeB 21 of a predetermined message transmitted from a control entity (e.g., ProSe function entity 4 or MME 31) that relates to the sidelink communication and is located in a higher-level network (e.g., EPC 3).

In block 302, in response to the detection of the event in block 301, the eNodeB 21 acquires location information of at least one of the plurality of UEs 1 (e.g., UE 1A or 1B) that participate in the sidelink communication. The acquisition of the location information of the UE(s) 1 by the eNodeB 21 is performed before the start of the sidelink communication. This location information is acquired by the UE 1 and indicates the current or latest location of the UE 1. The eNodeB 21 may receive the location information of the UE 1 directly from the UE 1 (i.e., via RRC signaling on an LTE-Uu interface). Alternatively, the eNodeB 21 may receive the location information of the UE 1 through a server.

The location information of the UE 1 preferably indicates a more detailed location than a cell-level location. For example, the location information of the UE 1 may include Global Navigation Satellite System (GNSS) location information that is obtained by a GNSS receiver possessed by the UE 1. The GNSS location information indicates latitude and longitude. Additionally or alternatively, the location information of the UE 1 may include Radio Frequency (RF) fingerprints. The RF fingerprints include information about peripheral cell measurement (e.g., cell ID (ECG1 or Cell-Id) and Reference Signal Received Power (RSRP)) measured by the UE 1.

The eNodeB 21 may acquire the location information of some or all of the plurality of UEs 1 that participate in the sidelink communication. For example, when the eNodeB 21 has already acquired detailed locations of some of the plurality of UEs 1 that participate in the sidelink communication by an RRC measurement report or the like, the eNodeB 21 may acquire the location information of one or more of the remaining UEs 1 regarding which the eNodeB 21 still has not obtained detailed locations.

By the operation shown in FIG. 3, the eNodeB 21 can take into account the location information of the UE(s) 1 when the eNodeB 21 performs various processes regarding the sidelink communication. In some implementations, the eNodeB 21 may take into account the location information of the UE(s) 1 when the eNodeB 21 determines whether to activate the sidelink communication, whether to permit the sidelink communication, or whether to allocate radio resources for the sidelink communication. For example, when the inter-terminal distance between the UEs 1A and 1B estimated from their location information is equal to or shorter than a threshold, the eNodeB 21 may allocate radio resources for the sidelink communication between the UEs 1A and 1B. Conversely, when the inter-terminal distance between the UEs 1A and 1B exceeds the threshold, the eNodeB 21 may reject a radio resource allocation request for the sidelink communication sent from the UE 1A or 1B.

In some implementations, the eNodeB 21 may take into account the location information of the UE(s) 1 when determining a radio setting for the sidelink communication. For example, the eNodeB 21 may determine a radio setting for the sidelink communication between the UEs 1A and 1B according to an inter-terminal distance between the UEs 1A and 1B estimated from their location information. This radio setting may designate at least one of a frequency resource, a time resource, transmission power, a modulation scheme, and a coding rate.

More specifically, the eNodeB 21 may increase transmission power permitted for the sidelink communication as the inter-terminal distance increases. Additionally or alternatively, when the inter-terminal distance exceeds a threshold, the eNodeB 21 may apply, to the sidelink communication, a modulation scheme having a smaller required carrier-to-noise ratio (CNR) than a modulation scheme used when the inter-terminal distance is shorter than the threshold. To put it differently, the adoption of a modulation scheme having a smaller required CNR means the adoption of a modulation scheme having a larger inter-point distance on a constellation (usually means a lower transmission speed). Additionally or alternatively, when the inter-terminal distance exceeds a threshold, the eNodeB 21 may apply, to the sidelink communication, a lower coding rate than when the inter-terminal distance is shorter than the threshold.

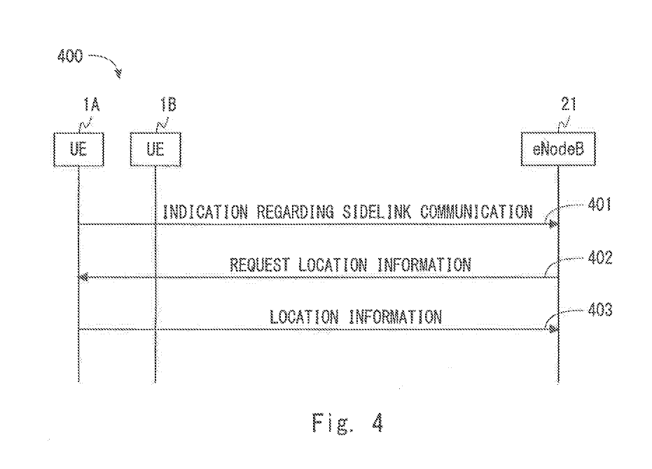

FIG. 4 is a sequence diagram showing an example (process 400) of an operation for acquiring the location information of the UE(s) 1 performed by the eNodeB 21. In block 401, the eNodeB 21 receives from the UE 1A an indication regarding the sidelink communication (e.g., ProSe Direct indication, Discovery Indication, or scheduling request with ProSe BSR). In block 402, in response to the reception of the indication regarding the sidelink communication sent from the UE 1A, the eNodeB 21 requests the UE 1A to send its location information. In block 403, the eNodeB 21 receives the location information from the UE 1A.

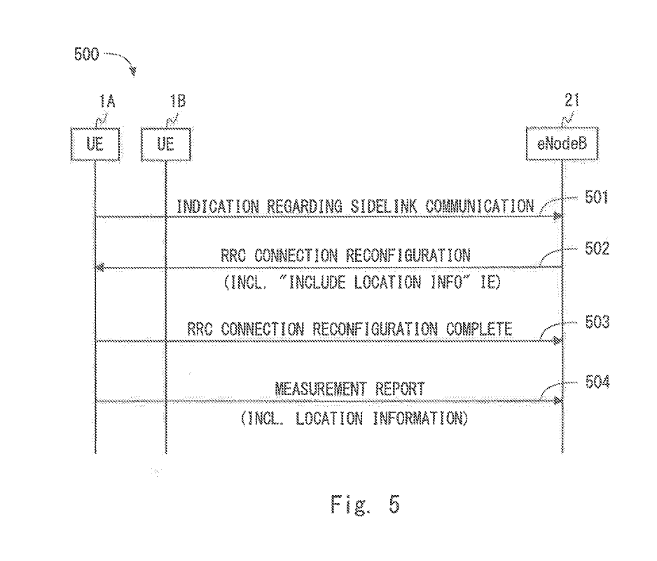

FIG. 5 is a sequence diagram showing an example (process 500) of an operation for acquiring location information of the UE(s) 1 performed by the eNodeB 21. The process 500 shown in FIG. 5 is a specific example of the process 400 shown in FIG. 4. In the example shown in FIG. 5, the eNodeB 21 acquires location information of the UE 1 by using an existing RRC measurement procedure. Note that, an RRC measurement that is extended so as to include location information can be used for Minimization of Drive Tests (MDT) and is also referred to as an Immediate MDT measurement report (measurement information).

In block 501, the eNodeB 21 receives an indication regarding the sidelink communication from the UE 1A. In block 502, in response to the reception of the indication regarding the sidelink communication sent from the UE 1A (block 501), the eNodeB 21 transmits an RRC CONNECTION RECONFIGURATION message to the UE 1A. This RRC CONNECTION RECONFIGURATION message contains an “INCLUDE LOCATION INFO (includeLocationInfo)” information element (IE), The “INCLUDE LOCATION INFO” IE is designated in an RRC Measurement Configuration by the eNodeB 21 to request the UE 1 to include its location information in an RRC measurement report.

In block 503, the UE 1A transmits a response message (i.e., RRC CONNECTION RECONFIGURATION COMPLETE) to the RRC CONNECTION RECONFIGURATION message (block 502). In block 504, the UE 1A transmits to the eNodeB 21 an RRC measurement report including its location information.

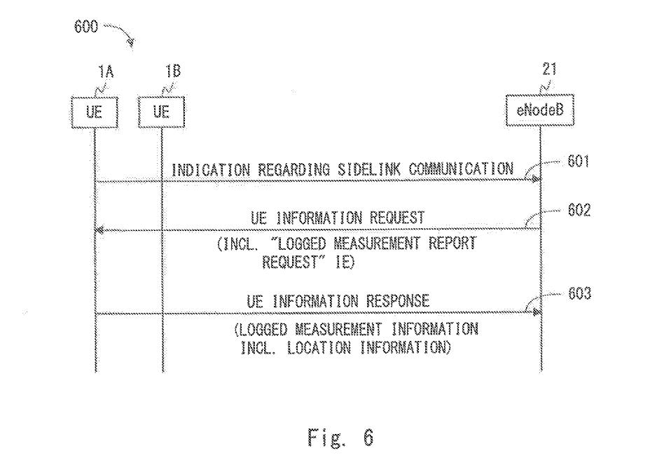

FIG. 6 is a sequence diagram showing an example (process 600) of an operation for acquiring location information of the UE(s) 1 performed by the eNodeB 21. The process 500 shown in FIG. 5 is a specific example of the process 400 shown in FIG. 4. In the example shown in FIG. 6, the eNodeB 21 acquires location information of the UE 1 by using a UE information procedure, which is one of existing RRC procedures.

In block 601, the eNodeB 21 receives an indication regarding the sidelink communication from the UE 1A. In block 602, in response to the reception of the indication regarding the sidelink communication sent from the UE 1A (block 601), the eNodeB 21 transmits a UE INFORMATION REQUEST message to the UE 1A. This UE INFORMATION REQUEST message includes a “LOGGED MEASUREMENT REPORT REQUEST (logMeasReportReq)” IE. The “LOGGED MEASUREMENT REPORT REQUEST” IE is used to request the UE 1 to report logged measurement information stored in the UE 1 to the eNodeB 21. The logged measurement information can be used for the MDT and is also referred to as a Logged MDT measurement report (measurement information). The logged measurement information includes location information (e.g., GNSS location information) of the UE 1 at the time when radio measurement is performed.

In block 603, in response to the UE INFORMATION REQUEST message (block 602), the UE 1A transmits a UE INFORMATION RESPONSE message. This UE INFORMATION RESPONSE message includes logged measurement information including the location information of the UE 1A.

According to the procedure shown in FIG. 5 or 6, the eNodeB 21 can use an ordinary RRC procedure specified in the current 3GPP specifications to acquire the location information of the UE 1, thereby reducing the impacts on the existing specifications regarding the UE 1.

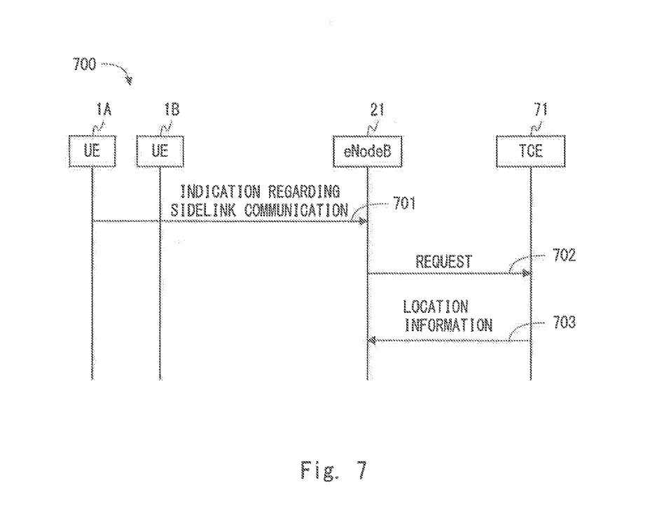

FIG. 7 is a sequence diagram showing an example (process 700) of an operation for acquiring location information of the UE 1 performed by the eNodeB 21. As shown in FIG. 7, the eNodeB 21 may receive location information of the UE(s) 1 through a server. In the example shown in FIG. 7, the eNodeB 21 receives an indication regarding the sidelink communication from the UE 1A (block 701). Then, the eNodeB 21 requests location information of the UE(s) 1 (UE 1A or 1B, or both of them) from a Trace Collection Entity (TCE) 71 (block 702) and acquires this location information from the TCE 71 (block 703). The Trace Collection Entity (TCE) is a node that collects Logged MDT measurement information or immediate MDT measurement information. The eNodeB 21 may use the latest location information of the UE 1 included in the latest MDT measurement information collected by the TCE 71. The server, which the eNodeB 21 accesses to acquire the location information of the UE(s) 1, may be a server (e.g., SLP 34) different from the TCE.

According to the procedure shown in FIG. 7, since the eNodeB 21 acquires the location information of the UE(s) 1 through a server (e.g., TCE 71 or SLP 34) different from the UE 1, the signaling between the UE(s) 1 and the eNodeB 21 can be reduced. As a result of this, the load on the UE(s) 1 can be reduced.

In the above-described procedures shown in FIGS. 4 to 7, for example, when the indication regarding the sidelink communication (block 401, 501, 601 or 701) indicates the UE 1B, the eNodeB 21 may acquire location information from the UE 1B as well as (or instead of) from the UE 1A.

### Second Embodiment

This embodiment provides a modified example of the control procedure regarding the sidelink communication described in the first embodiment. A configuration example of a public land mobile network according to this embodiment is the same as that shown in FIGS. 1 and 2.

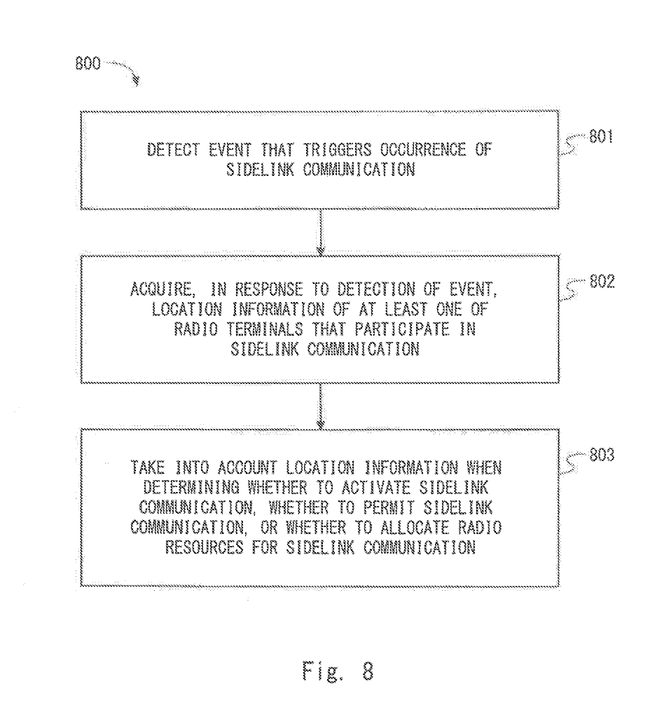

FIG. 8 is a flowchart showing an example (process 800) of an operation of an eNodeB 21 according to this embodiment. Processes in blocks 801 and 802 are similar to those in blocks 301 and 302 shown in FIG. 3. In block 803, the eNodeB 21 takes into account the location information of the UE 1 when it determines whether to activate sidelink communication, whether to permit the sidelink communication, or whether to allocate radio resources for the sidelink communication.

For example, as already described, when the inter-terminal distance between the UEs 1A and 1B estimated from their location information is equal to or shorter than a threshold, the eNodeB 21 may allocate radio resources for the sidelink communication between the UEs 1A and 1B. Conversely, when the inter-terminal distance between the UEs 1A and 1B exceeds the threshold, the eNodeB 21 may reject a radio resource allocation request for the sidelink communication sent from the UE 1A or 1B. In this way, it is possible to prevent waste of radio resources and waste of battery power of the UE(s) 1, which would otherwise occur when the inter-terminal distance is too long and hence the UEs 1A and 1B cannot perform the sidelink communication.

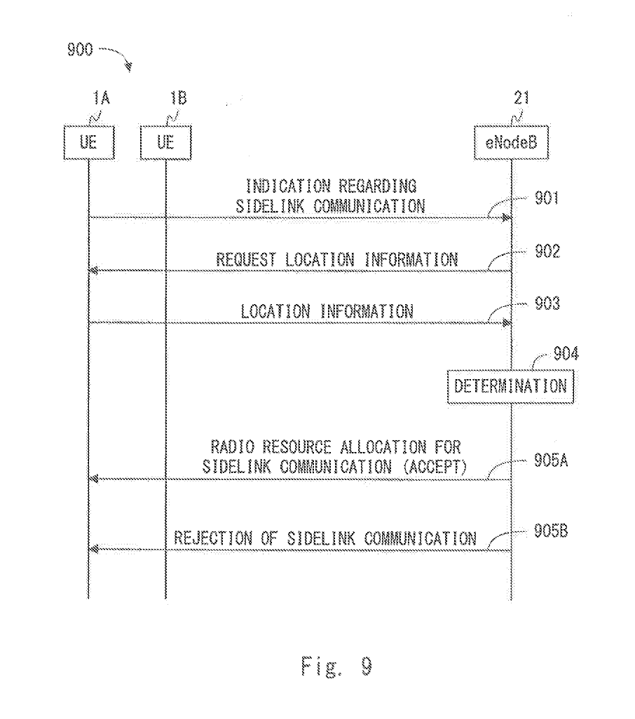

FIG. 9 is a sequence diagram showing an example (process 900) of a sidelink control procedure according to this embodiment. Processes in blocks 901 to 903 are similar to those in blocks 401 to 403 shown in FIG. 4. In block 904, the eNodeB 21 determines, based on the location information of the UE 1A, whether to permit the sidelink communication requested by the UE 1A or to permit allocation of radio resources to this sidelink communication. The eNodeB 21 performs either block 905A or block 905B according to a result of the determination in block 904.

When the eNodeB 21 permits the sidelink communication or the resource allocation, the eNodeB 21 configures radio resources for the sidelink communication in the UE 1A (block 905A). For example, the eNodeB 21 may schedule resources for sidelink control and data for the UE 1A in accordance with the Scheduled resource allocation of ProSe direct communication. Alternatively, the eNodeB 21 may allocate to the UE 1A, via dedicated RRC signaling, a resource pool(s) for the Autonomous resource selection of ProSe direct communication. Alternatively, the eNodeB 21 may allocate, to the UE 1A, resources for announcement from a resource pool that Is configured in UEs for monitoring in accordance with the Scheduled resource allocation of ProSe direct discovery.

On the other hand, when the eNodeB 21 rejects the sidelink communication or the resource allocation, the eNodeB 21 transmits to the UE 1A a message indicating that the sidelink communication is rejected (block 905B).

It should be noted that the procedure shown in FIG. 9 is merely an example. As described in the first embodiment, the eNodeB 21 may acquire the location information of the UE 1B instead of the location information of the UE 1A. Further, the eNodeB 21 may acquire the location information of one or both of the UE 1A and 1B from a server.

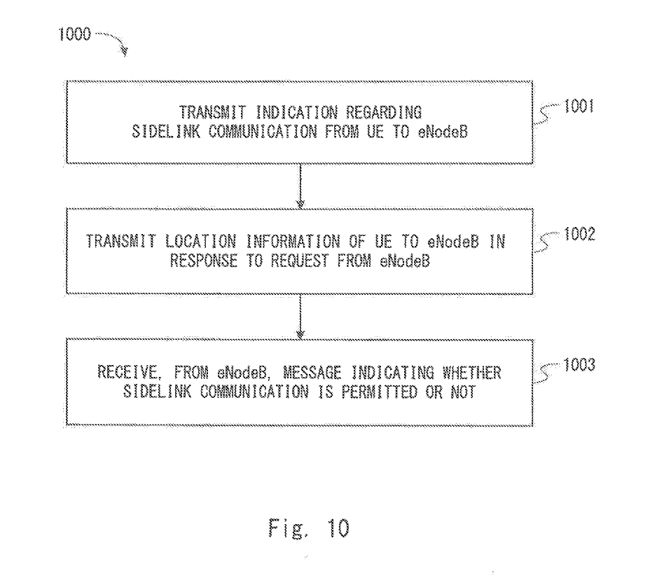

FIG. 10 is a flowchart showing an example (process 1000) of an operation of the UE 1 according to this embodiment. In block 1001, the UE 1 transmits an indication regarding the sidelink communication to the eNodeB 21. In block 1002, In response to a request from the eNodeB 21, the UE 1 transmits Its location information to the eNodeB 21. In block 1003, the UE 1 receives from the eNodeB 21 a message indicating whether the sidelink communication is permitted or not.

In this embodiment, the eNodeB 21 takes into account the location information of the UE(s) 1 when it determines whether to activate the sidelink communication, whether to permit the sidelink communication, or whether to allocate radio resources for the sidelink communication. As a result of this, the eNodeB 21 can perform efficient control for sidelink communication (e.g., radio resource allocation) in which the location of the UE(s) 1 is taken into account.

### Third Embodiment

This embodiment provides a modified example of the control procedure regarding the sidelink communication described in the first embodiment. A configuration example of a public land mobile network according to this embodiment is the same as that shown in FIGS. 1 and 2.

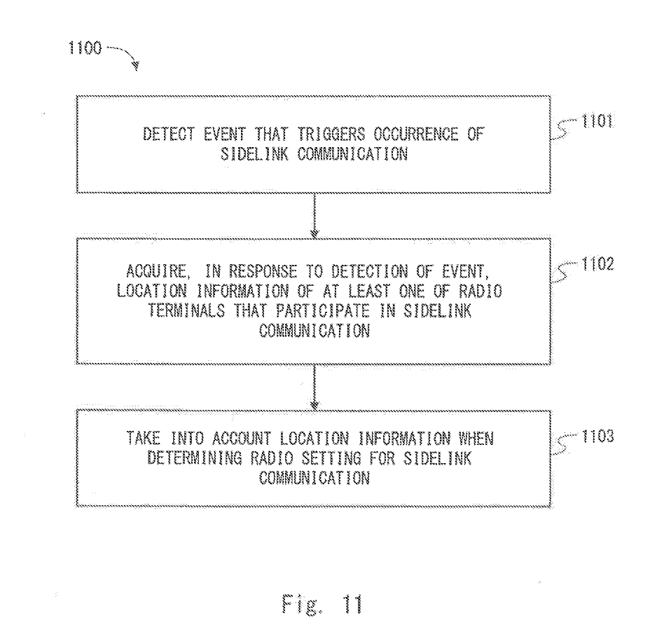

FIG. 11 is a flowchart showing an example (process 1100) of an operation of an eNodeB 21 according to this embodiment. Processes in blocks 1101 and 1102 are similar to those In blocks 301 and 302 shown in FIG. 3. In block 1103, the eNodeB 21 takes into account the location Information of the UE 1 when it determines a radio setting for the sidelink communication.

For example, as already described, the eNodeB 21 may determine a radio setting for the sidelink communication between the UEs 1A and 1B according to an inter-terminal distance between the UEs 1A and 1B estimated from their location information. This radio setting may designate at least one of a frequency resource, a time resource, transmission power, a modulation scheme, and a coding rate. The eNodeB 21 may increase transmission power permitted for the sidelink communication as the inter-terminal distance increases. Additionally or alternatively, when the inter-terminal distance exceeds a threshold, the eNodeB 21 may apply, to the sidelink communication, a modulation scheme having a smaller required CNR than a modulation scheme used when the inter-terminal distance is shorter than the threshold. Additionally or alternatively, when the inter-terminal distance exceeds a threshold, the eNodeB 21 may apply, to the sidelink communication, a lower coding rate than when the inter-terminal distance is shorter than the threshold.

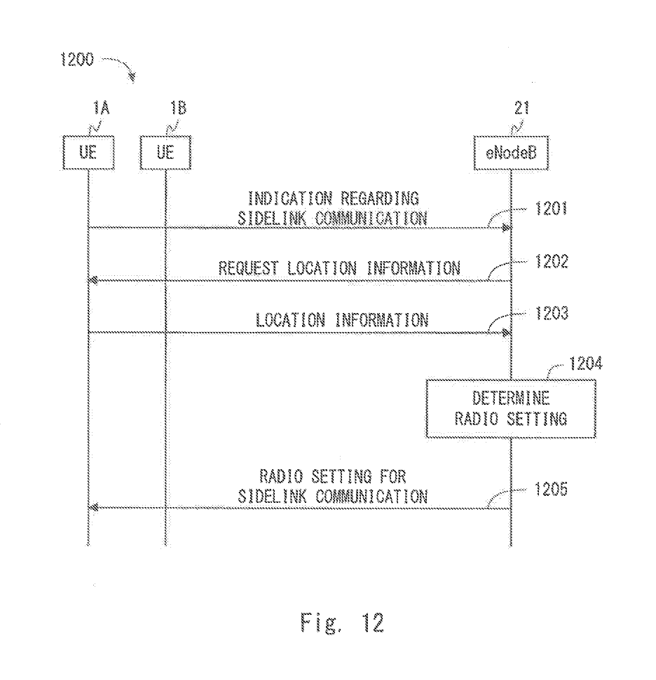

FIG. 12 is a sequence diagram showing an example (process 1200) of a sidelink control procedure according to this embodiment. Processes in blocks 1201 to 1 203 are similar to those in blocks 401 to 403 shown in FIG. 4. In block 1204, the eNodeB 21 determines a radio setting for the sidelink communication for the UE 1A based on the location information of the UE 1A. In block 1205, the eNodeB 21 transmits the determined radio setting to the UE 1A.

It should be noted that the procedure shown in FIG. 12 is merely an example. As described in the first embodiment, the eNodeB 21 may acquire the location information of the UE 1B instead of the location information of the UE 1A. Further, the eNodeB 21 may acquire the location information of one or both of the UE 1A and 1B from a server.

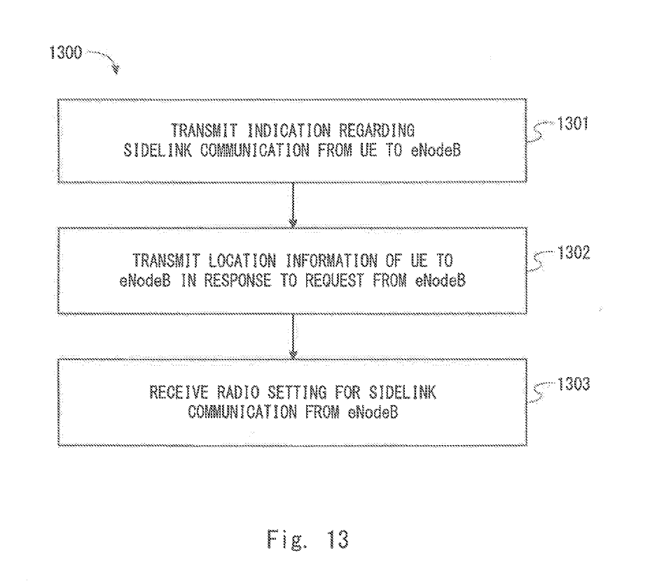

FIG. 13 is a flowchart showing an example (process 1300) of an operation of the UE 1 according to this embodiment. Processes in blocks 1301 and 1302 are similar to those In blocks 1001 and 1002 shown in FIG. 10. In block 1303, the UE 1 receives a radio setting for the sidelink communication from the eNodeB 21.

In this embodiment, the eNodeB 21 takes into account the location information of the UE 1 when the eNodeB 21 determines the radio setting (e.g., transmission power, modulation scheme, coding rate, or any combination of them) for the sidelink communication. As a result of this, the eNodeB 21 can make an efficient radio setting in which the location of the UE(s) 1 is taken into account.

Lastly, configuration examples of the base station (e.g., eNodeB 21) and the radio terminal (e.g., UE 1) according to the above-described embodiments are described. The base station (eNodeB 21) described in the above-described embodiments may include a wireless transceiver for communicating with radio terminals (UEs 1) and a controller coupled to the wireless transceiver. The controller performs processes of the base station (eNodeB 21) described in the above-described embodiments.

The radio terminal (UE 1) described in the above-described embodiments may include a wireless transceiver for communicating with a base station (eNodeB 21) and a controller coupled to the wireless transceiver. The controller performs processes of the radio terminal (UE 1) described in the above-described embodiments.

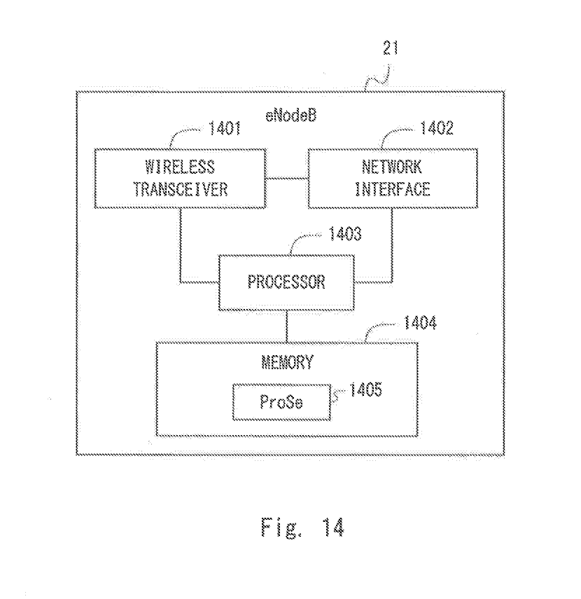

FIG. 14 is a block diagram showing a configuration example of the eNodeB 21 according to the above-described embodiments. Referring to FIG. 14, the eNodeB 21 includes a wireless transceiver 1401, a network interface 1402, a processor 1403, and a memory 1404. The wireless transceiver 1401 is configured to communicate with UEs 1. The network interface 1402 is used to communicate with a network node (e.g., MME 31, an S/P-GW 32, and a TCE 71), The network interface 1402 may include, for example, a Network Interface Card (NIC) conforming to the IEEE 802.3 series.

The processor 1403 loads software codes (computer programs) from the memory 1404 and executes the loaded software codes, and thereby performs processes of the eNodeB 21 described in the above-described embodiments. The processor 1403 may be, for example, a microprocessor, a Micro Processing Unit (MPU), or a Central Processing Unit (CPU). The processor 1403 may include a plurality of processors. The processor 1403 may include a baseband processor and an application processor. The baseband processor performs digital baseband signal processing (i.e., data-plane processing) and control-plane processing for wireless communication. The baseband processor may include a modem processor (e.g.. Digital Signal Processor (DSP)) that performs the digital baseband signal processing and a protocol-stack-processor (e.g., CPU or an MPU) that performs the control-plane processing. Meanwhile, the application processor executes a system software program (Operating System (OS)) and various application programs (e.g., a call application, a WEB browser, a mailer, a camera operation application, and a music player application) from a memory 406 or from other memories (not shown), thereby providing various functions of the UE1.

The memory 1404 consists of a volatile memory and a nonvolatile memory. The volatile memory is, for example, a Static Random Access Memory (SRAM), a Dynamic RAM (DRAM), or a combination of them. The nonvolatile memory is, for example, a Mask Read Only Memory (MROM), a Programmable ROM (PROM), a flash memory, a hard disk drive, or any combination of them. The memory 1404 may include a storage that is remotely arranged from the processor 1403. In this case, the processor 1403 may access the memory 1404 through the network interface 1402 or an I/O interface (not shown).

In the example shown in FIG. 14, the memory 1404 is used to store software modules including a ProSe module 1405. The ProSe module 1405 includes instructions and data necessary for performing processes of the eNodeB 21 regarding the sidelink communication described in the above-described embodiments. The ProSe module 1405 may include a plurality of software modules. The processor 1403 loads software modules including the ProSe module 1405 from the memory 1404 and executes these loaded modules, and thereby performing the processes of the eNodeB 21 described in the above-described embodiments.

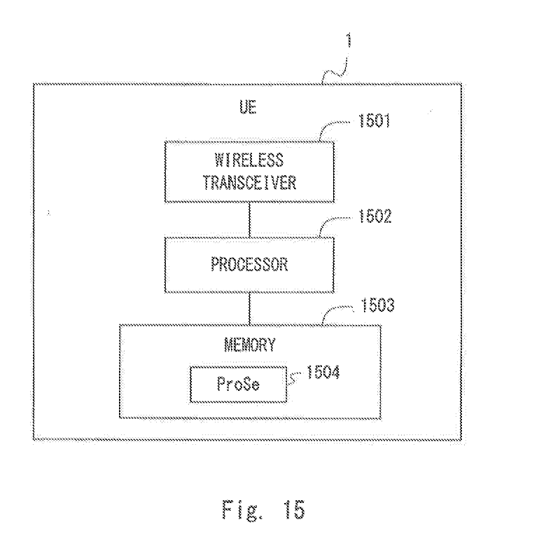

FIG. 15 shows a configuration example of the UE 1. Referring to FIG. 15, the UE 1 includes a wireless transceiver 1501, a processor 1502, and a memory 1503. The wireless transceiver 1501, the processor 1502, the memory 1503 or any combination thereof can be referred to as circuits or circuitry. The wireless transceiver 1501 is used for communication (101 or 102 in FIG. 1) with the E-UTRAN 2 (eNodeB 21) and for ProSe direct communication (103 in FIG. 1). The wireless transceiver 1501 may include a plurality of transceivers, for example, an E-UTRA (Long Term Evolution (LTE)) transceiver and a WLAN transceiver.

The processor 1502 loads software (computer program) from the memory 1503 and executes these loaded software, and thereby performs processes of the UE 1, i.e., the processes described with reference to the sequence diagrams and the flowchart in the above-described embodiments (e.g., process 400, 500, 600, 700, 800, 820, 900 or 920). The processor 1502 may be, for example, a microprocessor, an MPU, or a CPU. The processor 1502 may include a plurality of processors.

The memory 1503 consists of a volatile memory and a nonvolatile memory. The volatile memory is, for example, an SRAM, a DRAM, or a combination of them. The nonvolatile memory is, for example, an MROM, a PROM, a flash memory, a hard disk drive, or any combination of them. The memory 1503 may include a storage that is located apart from the processor 1502. In this case, the processor 1502 may access the memory 1503 through an I/O interface (not shown).

In the example shown in FIG. 15, the memory 1503 is used to store software modules including a ProSe module 1504. The ProSe module 1504 includes instructions and data necessary for performing processes of the UE 1 described in the above-described embodiments. The ProSe module 1504 may include a plurality of software modules. The processor 1502 loads software modules including the ProSe module 1504 from the memory 1503 and executes these loaded modules, and thereby performing the processes of the UE 1 described in the above-described embodiments.

As described above with reference to FIGS. 14 and 15, each of the processors included in the eNodeB 21 and the UE 1 according to the above-described embodiments executes one or more programs including instructions to cause a computer to perform an algorithm described with reference to the drawings. These programs may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a Compact Disc Read Only Memory (CD-ROM), CD-R, CD-R/W, and a semiconductor memory (such as a mask ROM, a Programmable ROM (PROM), an Erasable PROM (EPROM), a flash ROM, and a Random Access Memory (RAM)). These programs may be supplied to computers by using various types of transitory computer readable media. Examples of the transitory computer readable media include an electrical signal, an optical signal, and an electromagnetic wave. The transitory computer readable media can be used to supply programs to a computer through a wire communication path such as an electrical wire and an optical fiber, or wireless communication path.

### Other Embodiments

Each of the above-described embodiments may be used individually, or two or more of the embodiments may be appropriately combined with one another.

The processes of taking into account the location information of the UE(s) 1 at the time of (a) the start of sidelink communication, (b) the permission of the sidelink communication, (c) the allocation of radio resources for the sidelink communication, and (d) the configuration of a radio setting for the sidelink communication described above in the second and third embodiments may be performed by using location information of the UE 1 acquired in advance by the eNodeB 21, before the eNodeB 21 detects an event that triggers an occurrence of the sidelink communication. That is, when the eNodeB 21 activates a sidelink communication including at least one of direct discovery and direct communication, permits the sidelink communication, allocates radio resources for the sidelink communication, or determines a radio setting for the sidelink communication, the eNodeB 21 may take into account location information of at least one of a plurality of UEs 1 that participate in the sidelink communication.

Further, a part or the whole of the radio setting for the sidelink communication may be performed by the UE 1 instead of the eNodeB 21. In this case, for example, the eNodeB 21 provides information about the estimated inter-terminal distance to the UE 1A and then the UE 1A determines transmission power, a modulation scheme, a coding rate, or the like based on this information. Note that the information provided to the UE 1A by the eNodeB 21 may be location information of the UE 1B instead of the information about the estimated inter-terminal distance.

In the second and third embodiments, the eNodeB 21 may further take into account measurement information of an uplink radio resource acquired by any one of the plurality of UEs 1. In some implementations, the eNodeB 21 may receive measurement information of an uplink radio resource during the procedure for acquiring the RRC measurement information (or Immediate MDT measurement report) or the Logged measurement information (or Logged MDT measurement report) described above with reference to FIGS. 5 and 6. In the 3GPP ProSe, a subset of uplink resources is used for sidelink communication in an in-coverage state. For example, the eNodeB 21 may take into account the uplink radio resource measurement information acquired by the UE 1 to allocate, to the sidelink communication, uplink radio resources that provide good quality in a place where the UE 1 is located. In this way, it is possible to contribute to improving the quality of the sidelink communication.

Further, the uplink radio resource measurement information acquired by the UE 1 may be taken into account by the eNodeB 21 independently of the location information of the UE 1. That is, when the eNodeB 21 activates the sidelink communication including at least one of direct discovery and direct communication, permits the sidelink communication, allocates radio resources for the sidelink communication, or determines a radio setting for the sidelink communication, the eNodeB 21 may take into account the uplink radio resource measurement information acquired by a plurality of UEs 1 that participate in the sidelink communication.

In the above-described embodiments, cases where the UEs 1A and 1B that perform sidelink communication are located in the same cell (i.e., intra-cell) are described based on FIG. 1. However, the UEs 1A and 1B may be located in different cells (e.g., adjacent cells) from each other (i.e., inter-cell). In this case, the eNodeB 21 may perform radio resource allocation and a radio setting for the Inter-cell sidelink communication based on location information of a UE 1 located in its own cell 22, or location information of a UE 1 located in a cell managed by another eNodeB, or both of them.

The above-described embodiments are described by using specific examples mainly related to the EPS. However, these embodiments may be applied to other mobile communication systems such as a Universal Mobile Telecommunications System (UMTS), a 3GPP2 CDMA2000 system (1×RTT, High Rate Packet Data (HRPD)), a Global System for Mobile communications (GSM)/General packet radio service (GPRS) system, and a mobile WiMAX system. In this case, the processes or the procedures regarding sidelink communication performed by the eNodeB 21 described in the above-described embodiments may be performed by a radio access network node having a radio resource management function (e.g., Radio Network Controller (RNC) in a UMTS or Base Station Controller (BSC) in a GSM system).

Further, the above-described embodiments are merely examples of applications of the technical ideas obtained by the inventor. Needless to say, these technical ideas are not limited to the above-described embodiments and various modifications can be made thereto.

This application is based upon and claims the benefit of priority from Japanese patent application No. 2015-036287, filed on Feb. 26, 2015, the disclosure of which is incorporated herein in its entirety by reference.

### REFERENCE SIGNS LIST

1A, 1B User Equipment (UE)

2 Evolved Universal Terrestrial Radio Access Network (E-UTRAN)

3 Evolved Packet Core (EPC)

4 Proximity-based Services (ProSe) function entity

5 ProSe application server

21 evolved NodeB (eNodeB)

22 cell

33 Home Subscriber Server (HSS)

34 Secure User Plane Location (SUPL) Location Platform (SLP)

71 Trace Collection Entity (TCE)

100 Public Land Mobile Network (PLMN)

103 inter-UE direct interface (sidelink)

1. A radio access network node located in a radio access network, the radio access network node comprising:
a memory; and
at least one processor coupled to the memory, wherein
the at least one processor is configured to:
detect an event that triggers an occurrence of sidelink communication including at least one of direct discovery and direct communication; and
acquire, in response to detection of the event, location information of at least one of a plurality of radio terminals that participate in the sidelink communication,

2. The radio access network node according to claim 1, wherein the at least one processor is further configured to take into account the location information when determining a radio setting for the sidelink communication.

3. The radio access network node according to claim 2, wherein the at least one processor is configured to determine the radio setting according to a distance between the at least one radio terminal and another radio terminal estimated based on the location information.

4. The radio access network node according to claim 2, wherein the radio setting designates at least one of a frequency resource, a time resource, transmission power, a modulation scheme, and a coding rate.

5. The radio access network node according to claim 1, wherein the at least one processor is configured to request a radio measurement report from the at least one radio terminal in response to the detection of the event, and receive the radio measurement report including the location information from the at least one radio terminal.

6. The radio access network node according to claim 5, wherein the radio measurement report is an Immediate Minimization of Drive Tests (MDT) measurement report or a Logged MDT measurement report.

7. The radio access network node according to claim 5, wherein the radio measurement report further includes measurement information of an uplink radio resource available for the sidelink communication.

8. The radio access network node according to claim 7, wherein the at least one processor is further configured to take into account the measurement information of the uplink radio resource when determining a radio setting for the sidelink communication.

9. The radio access network node according to claim 1, wherein the at least one processor is configured to receive the location information through a server.

10. The radio access network node according to claim 1, wherein the at least one processor is further configured to take into account the location information when determining whether to activate the sidelink communication, whether to permit the sidelink communication, or whether to allocate a radio resource for the sidelink communication.

11. The radio access network node according to claim 10, wherein the at least one processor is further configured to provide a radio setting for the sidelink communication to the at least one radio terminal when activating the sidelink communication, permitting the sidelink communication, or allocating a radio resource for the sidelink communication.

12. The radio access network node according to claim 1, wherein the event includes at least one of:
(a) reception by the radio access network node of an indication regarding the sidelink communication transmitted from one or the plurality of radio terminals; and
(b) reception by the radio access network node of a predetermined message sent from a control entity that relates to the sidelink communication and is located in a higher-level network.

13. The radio access network node according to claim 1, wherein the location information includes at least one of location information obtained by a Global Navigation Satellite System (GNSS) receiver and Radio Frequency (RF) fingerprint information.

14. A radio terminal comprising:
a memory; and
at least one processor coupled to the memory, wherein
the at least one processor is configured to:
transmit to a radio access network node an indication regarding sidelink communication including at least one of direct discovery and direct communication;
transmit location information of the radio terminal to the radio access network node in response to a request from the radio access network node that has received the indication; and
receive from the radio access network node a message indicating whether the sidelink communication is permitted or not, or indicating a radio setting for the sidelink communication.

15. The radio terminal according to claim 14, wherein the at least one processor is configured to transmit a radio measurement report including the location information to the radio access network node in response to the request from the radio access network node.

16. The radio terminal according to claim 15, wherein the radio measurement report is an Immediate Minimization of Drive Tests (MDT) measurement report or a Logged MDT measurement report.

17. The radio terminal according to claim 15, wherein the radio measurement report further includes measurement information of an uplink radio resource available for the sidelink communication.

18. The radio terminal according to claim 14, wherein the radio setting for the sidelink communication designates at least one of a frequency resource, a time resource, transmission power, a modulation scheme, and a coding rate.

19. The radio terminal according to claim 14, wherein the indication indicates: the radio terminal wants to perform the sidelink communication; the radio terminal has an interest in the sidelink communication; or the radio terminal requests radio resource allocation for the sidelink communication.

20. A method performed by a radio access network node located in a radio access network, the method comprising:
detecting an event that triggers an occurrence of sidelink communication including at least one of direct discovery and direct communication; and
acquiring, in response to detection of the event, location information of at least one of a plurality of radio terminals that participate in the sidelink communication.

21-48. (canceled)
